(19) United States
(12) Patent Application Publication
(10) Pub. No.: US 2012/0268269 A1
(43) Pub. Date: Oct. 25, 2012

(54) THREAT SCORE GENERATION

(75) Inventor: Thomas Francis Doyle, San Diego, CA (US)

(73) Assignee: QUALCOMM Incorporated, San Diego, CA (US)

(21) Appl. No.: 13/090,129

(22) Filed: Apr. 19, 2011

(51) Int. Cl. G08B 1/08

(52) U.S. Cl. 340/539.13

(57) ABSTRACT

The subject matter disclosed herein relates to systems, methods, devices, apparatuses, articles, etc. for generation of a threat score. For certain example implementations, a method may comprise obtaining one or more first attributes of a first person and one or more second attributes of a second person. A first location digest indicative of one or more locations that are associated with the first person, who may be associated with a mobile device, and a second location digest indicative of one or more locations that are associated with the second person may be obtained. A threat score of the first person with respect to the second person may be generated based, at least in part, on the one or more first attributes of the first person, the one or more second attributes of the second person, the first location digest, and the second location digest. Other example implementations are described herein.

### BACKGROUND

1. Field

The subject matter disclosed herein relates to threat score generation, and by way of example but not limitation, to generation of a threat score of a first person, such as a potential predator, with respect to a second person, such as a potential victim.

2. Information

Perpetrators of attacks may engage in harassment, physical harms, crimes, affronts to human dignity, or other forms of attacks on victims. Such perpetrators may rely on surprise to bring harm to their victims. For example, a would-be perpetrator may attempt to sneak up on a potential victim and attack without providing the potential victim an opportunity to prepare for, avoid, or stop an attack. If a potential victim likely has no warning of an impending attack, then a would-be perpetrator may be further emboldened to commence an attack because a potential victim's ability to resist may be lessened without benefiting from a warning. On the other hand, if warning of an impending attack were to be made to a potential victim or to the authorities, a possible attack may be averted.

### BRIEF DESCRIPTION OF THE FIGURES

Non-limiting and non-exhaustive aspects, features, etc. will be described with reference to the following figures, wherein like reference numerals refer to like parts throughout the various figures.

FIG. 1 is a schematic diagram of an example environment that may include multiple persons and with which a threat score generator may be employed to generate a threat score according to an implementation.

FIG. 2 is a schematic diagram of an example classification mechanism that may be employed to obtain a potential predator classification or a potential victim classification for persons according to an implementation.

FIG. 3 is a schematic diagram of an example location digest that may be associated with a person according to an implementation.

FIG. 4 is a schematic diagram of an example threat score generation mechanism that may generate a threat score based, at least in part, on one or more attributes of persons or at least one location digest according to an implementation.

FIG. 5 is a flow diagram illustrating an example method for generating a threat score of a first person with respect to a second person according to an implementation.

FIG. 6 is a flow diagram illustrating an example process for generating a threat score according to an implementation.

FIG. 7 is a schematic diagram illustrating an example mechanism for converting a threat score to a threat category according to an implementation.

FIG. 8 is a flow diagram illustrating an example specific process for generating a threat score according to an implementation.

FIG. 9 is a schematic diagram illustrating an example device, according to an implementation, that may implement one or more aspects of generating a threat score of a first person, such as a potential predator, with respect to a second person, such as a potential victim.

### SUMMARY

For certain example implementations, a method may comprise obtaining one or more first attributes of a first person, the first person being associated with at least a first mobile device that is to receive one or more signals and that is co-located with the first person; obtaining one or more second attributes of a second person; obtaining a first location digest indicative of one or more locations that are associated with the first person, the first location digest being based at least partly on at least one location estimate that is derived from the one or more signals received at the first mobile device; obtaining a second location digest indicative of one or more locations that are associated with the second person; and generating a threat score of the first person with respect to the second person based, at least in part, on the one or more first attributes of the first person, the one or more second attributes of the second person, the first location digest, and the second location digest.

For certain example implementations, a device may comprise at least one memory to store instructions; and one or more processors to execute said instructions to: obtain one or more first attributes of a first person, the first person being associated with at least a first mobile device that is to receive one or more signals and that is co-located with the first person; obtain one or more second attributes of a second person; obtain a first location digest indicative of one or more locations that are associated with the first person, the first location digest being based at least partly on at least one location estimate that is derived from the one or more signals received at the first mobile device; obtain a second location digest indicative of one or more locations that are associated with the second person; and generate a threat score of the first person with respect to the second person based, at least in part, on the one or more first attributes of the first person, the one or more second attributes of the second person, the first location digest, and the second location digest.

For certain example implementations, an apparatus may comprise: means for obtaining one or more first attributes of a first person, the first person being associated with at least a first mobile device that is to receive one or more signals and that is co-located with the first person; means for obtaining one or more second attributes of a second person; means for obtaining a first location digest indicative of one or more locations that are associated with the first person, the first location digest being based at least partly on at least one location estimate that is derived from the one or more signals received at the first mobile device; means for obtaining a second location digest indicative of one or more locations that are associated with the second person; and means for generating a threat score of the first person with respect to the second person based, at least in part, on the one or more first attributes of the first person, the one or more second attributes of the second person, the first location digest, and the second location digest.

For certain example implementations, an article may comprises: at least one storage medium having stored thereon instructions executable by one or more processors to: obtain one or more first attributes of a first person, the first person being associated with at least a first mobile device that is to receive one or more signals and that is co-located with the first person; obtain one or more second attributes of a second person; obtain a first location digest indicative of one or more locations that are associated with the first person, the first location digest being based at least partly on at least one location estimate that is derived from the one or more signals received at the first mobile device; obtain a second location digest indicative of one or more locations that are associated with the second person; and generate a threat score of the first person with respect to the second person based, at least in part, on the one or more first attributes of the first person, the one or more second attributes of the second person, the first location digest, and the second location digest.

It should be appreciated, however, that these are merely example implementations and that other implementations may be employed without deviating from claimed subject matter.

### DETAILED DESCRIPTION

Reference throughout this Specification to “a feature,” “one feature,” “an example,” “one example,” and so forth means that a particular feature, structure, characteristic, or aspect, etc. that is described in connection with a feature or example may be relevant to at least one feature or example of claimed subject matter. Thus, appearances of a phrase such as “in one example,” “an example,” “in one feature,” “a feature,” “in an example implementation,” or “for certain example implementations,” etc. in various places throughout this Specification may not necessarily all be referring to a same feature, example, or example implementation, etc. Furthermore, particular features, examples, structures, characteristics, or aspects, etc. may be combined in one or more example methods, example devices, example systems, or other example implementations, etc.

A would-be perpetrator may be monitored for violations of a protective order. For example, a protective order may require that a would-be perpetrator (e.g., a person having a criminal history involving victims who are minors) stay a prescribed distance from an elementary school. Alternatively, a protective order may require that a particular would-be perpetrator keep a certain distance from an individual that has been threatened or harmed in the past by the particular would-be perpetrator. If a would-be perpetrator violates the prescribed distance, an alarm may be triggered. Hence, if a first condition or a first and a second condition are true with respect to identified individuals, then an alarm may be triggered. Unfortunately, this can result in triggering of many false positive alarms, which may ultimately be discounted or even routinely ignored. This approach may also fail to trigger an alarm in an anticipatory fashion, especially if a would-be perpetrator were to carefully monitor their movements and just barely avoid violating a prescribed distance. Furthermore, such a scheme may fail to trigger an alarm if a would-be perpetrator is pursuing a potential victim who is previously unknown to the potential victim.

In contrast, a flexible approach may instead be implemented to reliably detect threats while reducing false positive alarms. In other words, a flexible approach may maintain a reliably-high rate of detection of potential threats and may also reduce an occurrence of false alarms, which false alarms can lead to genuine alarms being ignored. A scoring system may be implemented to account for a variety of environmental characteristics that may contribute to a threat assessment. Additionally or alternatively, example described approaches may categorize persons to preemptively generate alerts if a potential predator is targeting, for example, a previously-unknown potential victim or victims.

Law enforcement and criminal justice agencies routinely require certain individuals with a criminal history to wear tracking bracelets to enable determining the whereabouts of such individuals. Such individuals may include, for example, individuals that are required to stay within a particular geographic area, such as parolees, individuals under house arrest, or accused individuals that are released on bail, etc. A tracking wrist or ankle bracelet, the latter of which is sometimes called an anklet, may include a receiver that is capable of receiving and processing signals to estimate a location of the tracking bracelet. In one particular example, a receiver may be capable of acquiring and processing navigation signals from a satellite positioning system (SPS), such as the global positioning system (GPS). In another particular example, a receiver may be capable of acquiring signals transmitted from terrestrial transmitters (e.g., cellular base stations, IEEE std. 802.11 access points, WiMAX stations, or pseudolites, etc.) to enable use of trilateration to obtain location information for use in computing a location estimate using well known techniques. Once location information is acquired or collected at a mobile device, a mobile device may transmit location information to a remote or central server via, for example, a wireless communication link in a wide area network (WAN). It should be understood that an estimated location may be computed at a mobile device or remotely at a server or other fixed device (e.g., from signals or location information received at a mobile device). Movements of an individual may be monitored by applying, for instance, well known geofencing techniques.

In a similar fashion, a mobile device may be attached to pets; children; or elderly, or vulnerable, etc. individuals to track their whereabouts to prevent such animals or people from being lost or venturing into unsafe areas, for example. Like tracking bracelets as discussed above, these mobile devices may also include receivers to acquire and process signals to obtain location information for use in computing a location estimate. Mobile devices may further include transmitters that are capable of transmitting acquired or collected location information to a remote or central location via, for example, a wireless communication link in a WAN.

In an example implementation that includes two mobile devices, first location estimates of a first individual (e.g., a suspicious individual such as a criminal, a serial sex predator, or a parolee, etc.) who is co-located with a first mobile device may be monitored or evaluated relative to second location estimates of a second individual (e.g., a vulnerable individual such as a child, or an elderly person, etc.) who is co-located with a second mobile device to possibly set off an alert under certain conditions. A server may obtain location estimates of the first mobile device and the second mobile device via a WAN or other communication network(s). A server may evaluate one or more conditions to determine whether location or movement of the first mobile device is suggestive of a threat to the second individual as reflected by a threat score. Using one example approach, a distance between the first location(s) and the second location(s) may be computed as a Euclidian distance. If the computed distance is less than a particular threshold distance of one or more threshold distances, a threat score may be increased. If a threat score reaches a predetermined level corresponding to a given category, an alert signal may be generated to notify law enforcement authorities, for example.

For certain example implementations, one or more first attributes of a first person may be obtained. The first person may be associated with at least a first mobile device that is to receive one or more signals and that is co-located with the first person. One or more second attributes of a second person may be obtained. A first location digest indicative of one or more locations that are associated with the first person may be obtained. The first location digest may be based at least partly on at least one location estimate that is derived from the one or more signals that are received at the first mobile device. A second location digest indicative of one or more locations that are associated with the second person may be obtained. A threat score of the first person with respect to the second person may be generated based, at least in part, on the one or more first attributes of the first person, the one or more second attributes of the second person, the first location digest, and the second location digest. An alert may be issued or other action may be taken responsive at least partially to the threat score. A threat score generation process may additionally or alternatively consider one or more environmental characteristics, such as physical characteristics, situational characteristics, historical characteristics, or combinations thereof, etc.

For certain example implementations, a potential predator classification for at least a first person may be obtained. The first person may be associated with at least a first mobile device that is to receive one or more signals and that is co-located with the first person. A potential victim classification for at least a second person may also be obtained. The potential predator classification may be selected from a first group of multiple potential predator types, and the potential victim classification may be selected from a second group of multiple potential victim types. A first location digest associated with the first person and a second location digest associated with the second person may be obtained. The first location digest may be based at least partly on at least one location estimate that is derived from the one or more signals received at the first mobile device. A threat score of the first person with respect to the second person may be generated based, at least in part, on the potential predator classification, the potential victim classification, the first location digest, and the second location digest. An alert may be issued or other action may be taken responsive at least partially to the threat score.

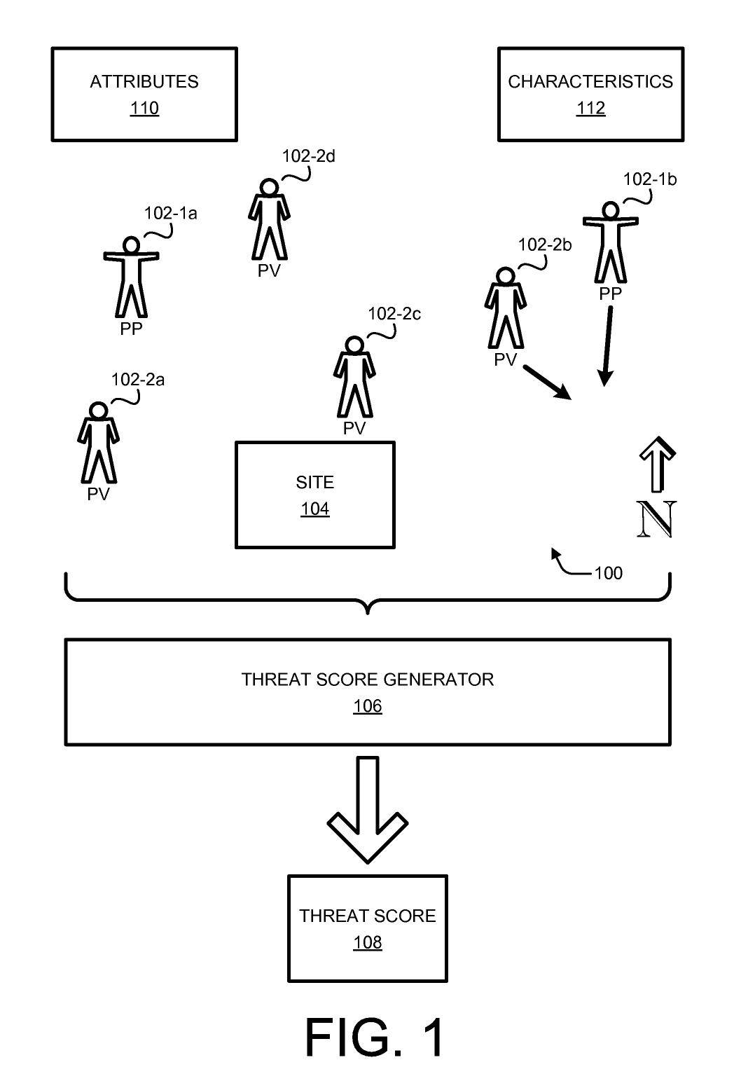

FIG. 1 is a schematic diagram of an example environment 100 that may include multiple persons 102 and with which a threat score generator 106 may be employed to generate a threat score 108 according to an implementation. As illustrated, environment 100 may include one or more persons 102 (e.g., a potential victim (PV), or a potential predator (PP), etc.), at least one site 104, one or more attributes 110, or one or more characteristics 112. With an environment 100, two or more persons 102 may be located therein previously, presently, repeatedly, or from time to time, etc.; may plan or intend to be located there in the future at one or more times; may be forbidden from being located there until a time period expires or indefinitely; or any combination thereof; etc.

For certain example implementations, a person 102 may comprise at least a first person or a second person. By way of example but not limitation, a person 102, such as a first person, may be identified as a potential predator 102-1, or a person 102, such as a second person, may be identified as a potential victim 102-2. A given person may be identified as a potential victim 102-2 at one moment, with respect to one person, or at one site, but the same given person may be identified as a potential predator 102-1 at another moment, with respect to another person, or at another site, etc. For example, an individual may be identified as a potential victim during one night if traveling in a violent neighborhood, but the same individual may be identified as a potential predator during the next day if traveling near a spouse who has acquired a restraining order against the individual.

As shown in FIG. 1 by way of example only, environment 100 may include four potential victims: potential victim 102-2a, potential victim 102-2b, potential victim 102-2c, or potential victim 102-2d. Environment 100 may include two potential predators: potential predator 102-1a or potential predator 102-1b. However, a threat score generator may be employed in environments with different numbers of potential predators 102-1 or potential victims 102-2 without departing from claimed subject matter. Potential victim 102-2c is shown proximate to a site 104. Potential victim 102-2b is shown moving in an approximately south-easterly direction at a given speed. Potential predator 102-1b is shown moving in an approximately southerly direction at a greater speed such that potential victim 102-2b and potential predator 102-1b appear to be converging toward a single location.

In example implementations, persons 102 may be associated with one or more attributes 110. Examples of attributes for persons 102 may include, but are not limited to, age, gender, having committed previous offenses (or recidivism), having been subjected to previous attacks (or victimhood), habits, marital status, psychological profile indications, employment, education, physical size, appearance, group affiliations, location history, residence, wealth, profession, income, avocations, or any combinations thereof, etc. A person's classification as a potential predator, a potential victim, a particular type of potential predator, a particular type of potential victim, some combination thereof, etc. may additionally or alternatively be considered an attribute 110 of a person 102. However, claimed subject matter is not limited to any particular attributes 110 for persons 102.

In example implementations, one or more characteristics 112 may be associated with environment 100. Characteristics 112 may be relevant to a threat score generation process to generate a threat score 108. Characteristics 112 may comprise, by way of example but not limitation, environmental characteristics such as physical characteristics, situational characteristics, historical characteristics, or combinations thereof, etc. Physical characteristics may include a condition of a site 104, whether a location is obstructed from view, weather, or darkness, just to name a few examples. Situational characteristics may include whether a location is populated or how closely a given potential victim matches a given potential predator's previous victims, just to name a couple of examples. Historical characteristics may include whether a proximity event has been repeated or whether a threat score has been repeatedly sufficiently high so as to trigger an alert. Also, a characteristic such as repeated “chance” meetings at night, for example, may be applicable to multiple categories of characteristics, such as being applicable to both historical and physical characteristics. However, claimed subject matter is not limited to any particular characteristics 112. Furthermore, additional or alternative examples of characteristics 112 are described herein below.

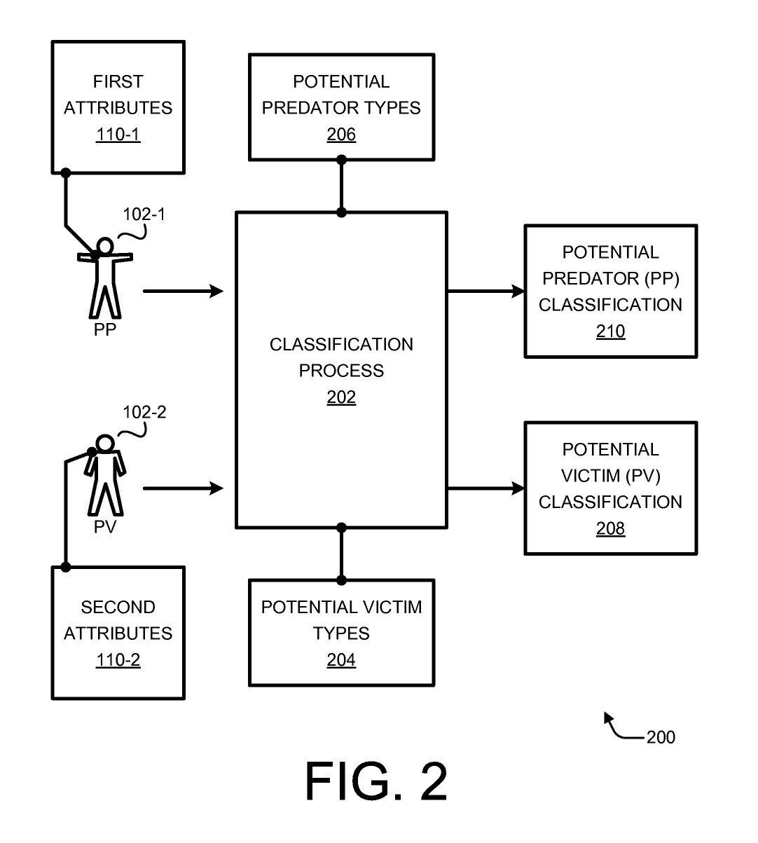

For certain example implementations, a threat score generator 106 may obtain as input signals attributes 110 of persons 102 or characteristics 112 of environment 100 to generate a threat score 108. Input signals may include, by way of example but not limitation, one or more attributes 110 of a potential victim 102-2, one or more characteristics of location(s) associated therewith, one or more attributes 110 of a potential predator 102-1, one or more characteristics of location(s) associated therewith, or one or more characteristics of site 104, combinations thereof, etc. Threat score generator 106 may generate a threat score 108 of at least one potential predator 102-1 with respect to at least one potential victim 102-2 based, at least in part, on attributes 110 of persons 102 or characteristics 112 of environment 100. A threat score 108 may be indicative of, or a metric for, a level or degree of danger that a first person (e.g., a potential predator 102-1) is causing to a second person (e.g., a potential victim 102-2). Example characteristics 112 that may be considered for generating a threat score 108 are described further herein below with particular reference to FIG. 2-4, 6, or 8, for example.

FIG. 2 is a schematic diagram 200 of an example classification mechanism that may be employed to obtain a potential victim classification 208 or a potential predator classification 210 for persons 102 according to an implementation. As illustrated, schematic diagram 200 may include a potential victim 102-2, one or more second attributes 110-2, a potential predator 102-1, one or more first attributes 110-1, a classification process 202, multiple potential victim types 204, multiple potential predator types 206, a potential victim classification 208, or a potential predator classification 210.

For certain example implementations, one or more second attributes 110-2 associated with a potential victim 102-2 may be applied to a classification process 202 to obtain a potential victim classification 208 that is selected from potential victim types 204. A selection classification may be based, at least partly, on one or more second attributes 110-2 of a potential victim 102-2. One or more first attributes 110-1 associated with a potential predator 102-1 may be applied to a classification process 202 to obtain a potential predator classification 210 that is selected from potential predator types 206. A selection classification may be based, at least partly, on one or more first attributes 110-1 of a potential predator 102-1.

Examples of a potential victim classification 208 that may be selected from potential victim types 204 may include, but are not limited to, a child, a child between 8 and 12 years of age or other particular age range, a minor, a woman between 18 and 30 years of age or another particular age range, an individual who is living near a known prior predator, an individual who drives a particular car or a car having a particular value range, an individual who exercises outside alone, a person that lives in a particular neighborhood and is within a certain age range, a person of a certain appearance, or any combinations thereof, etc. Examples of a potential predator classification 210 that may be selected from potential predator types 206 may include, but are not limited to, a previous predator, a previous offender, a recidivist of a particular criminal action or category, an individual that has exhibited suspicious behavior, an individual that is a subject of a restraining order, an individual that has been accused of or charged with a crime, or any combinations thereof, etc. However, claimed subject matter is not limited to any particular potential victim types 204 or potential predator types 206, or classifications selected there from.

A potential victim 102-2 may be assigned more than one potential victim classification 208 from between or among potential victim types 204. A potential predator 102-1 may be assigned more than one potential predator classification 210 from between or among potential predator types 206. In alternative example implementations, a separate or a different classification process 202 may be used to obtain a potential victim classification 208 for a potential victim 102-2 as compared to one used to obtain a potential predator classification 210 for a potential predator 102-1. With classification process 202, a potential victim classification 208 may be considered an additional or alternative attribute for second attribute 110-2, for example. Similarly, potential predator classification 210 may be considered an additional or alternative attribute for first attribute 110-1, for example

In some example implementation(s), classification process 202 may be performed, at least partially, using a manual assignment of at least one potential victim type as selected from potential victim types 204 or at least one potential predator type as selected from potential predator types 206 to a person 102. In some example implementation(s), classification process 202 may be performed, at least partially, using an automated assignment of at least one potential victim type of potential victim types 204 or at least one potential predator type of potential predator types 206 to a person 102. By way of example but not limitation, a classifier that is trained using machine learning principles may be used to automatically obtain classifications for persons with at least one classification process 202. However, claimed subject matter is not limited to any particular classification process.

With a manual classification process 202, for example, an individual may indicate an assignment of potential victim types or potential predator types locally at a device that is to generate a threat score using, e.g., a local application or other interface to indicate an assignment. Alternatively, an individual may indicate an assignment remotely from a device that is to generate a threat score using, e.g., a web interface or an application that may communicate over one or more networks. With an automated classification process 202, for example, a machine or application may indicate an assignment of potential victim types or potential predator types locally for a device that is to generate a threat score. Alternatively, a machine or application may indicate an assignment remotely from a device that is to generate a threat score and provide classifications via one or more network or signals that are transmitted via one or more networks.

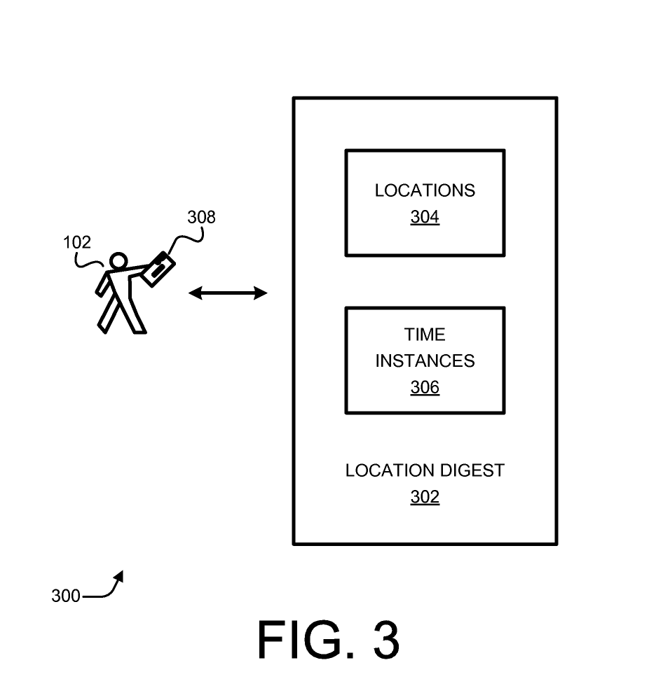

FIG. 3 is a schematic diagram 300 of an example location digest 302 that may be associated with a person 102 according to an implementation. As illustrated, schematic diagram 300 may include a person 102 that possesses or is co-located with a mobile device 308. Location digest 302 may include one or more locations 304 or one or more time instances 306. A location digest 302 may be indicative of one or more locations that are associated with a person 102. A “location digest”, as used herein, may refer to or comprise information that relates one or more locations to at least one associated person. For example, a status of a person's presence in relation to locations that a person has visited, is visiting, intends or has intent to visit, visits on a recurring basis, or is forbidden from visiting, etc. may be included as at least part of a location digest. A location digest may also include, by way of example only, timestamps that correspond to one or more locations. Time stamps may be indicative of, for example, instantaneous moments of time, ranges of time, any combination thereof, etc. However, these are merely examples of a location digest and claimed subject matter is not so limited.

For certain example implementations, a location digest 302 may be associated with a person 102 or may indicate or include one or more locations 304 that are associated with person 102. Locations 304 may be associated with a given person 102, by way of example but not limitation, if the given person 102 is present at or near at least one location of locations 304, if the given person 102 has been present at or near at least one location of locations 304, if the given person 102 expects or is scheduled to be present at or near at least one location of locations 304, if the given person 102 has been repeatedly present at or near at least one location of locations 304 a threshold number of times, if the given person 102 has been within a threshold distance to at least one location of locations 304, if the given person 102 is barred from being present at or near at least one location of locations 304, or any combination thereof, etc. A location digest 302 may indicate or be indicative of, by way of example only, time ranges during which a person 102 has been present at one or more locations 304, an average amount of time a person 102 spends at one or more locations 304, times or a time period during which a person is barred from being at one or more locations 304, any combination thereof, etc.

In example implementations for a location digest 302, a location of locations 304 may correspond to a time instant of time instances 306. A correspondence may establish a correlation between or among a particular location of locations 304 and one or more time instances of time instances 306. A location of locations 304 may comprise, by way of example but not limitation, an address, a building name, a place (e.g., a site 104), a neighborhood, a park, a set of satellite positioning system (SPS) coordinates, a route or path, a location estimate, a range from any such locations, or any combination thereof, etc. A time instance of time instances 306 may comprise, by way of example but not limitation, any one or more of: a moment in time (e.g., a timestamp), a time range in hours or minutes, a time of day, a day or days of the week, a day or days of the month, or any combination thereof, etc. However, claimed subject matter is not limited to any particular organization or content of locations 304, any particular organization or content of time instances 306, or any particular organization or content of location digest 302, and so forth.

In example implementations, a location digest 302 may be created or provided by a mobile device 308 that tracks or records a history of locations to which it has or is being carried. A mobile device 308 may comprise, by way of example but not limitation, a mobile phone or station, a user equipment, a laptop computer, a personal digital assistant (PDA), a tablet or pad-sized computing device, a portable entertainment appliance, a netbook, a monitoring bracelet or other monitoring device, a location-aware device, a personal navigational device, or any combination thereof, etc. Alternatively, a person or supervising authority may manually enter or provide a location digest 302 based on locations a person has visited, locations a person expects to visit, locations a person plans on being at or near repeatedly, locations that a person is barred from visiting, or any combination thereof, etc. A person may enter locations or time instants using, for example, a calendar along with a map. This may allow a person to effectively become a monitored person without wearing a mobile device that tracks their movements. For example, a parent may register a child by entering when or where the child is normally at home, when or where the child is at school, when or where the child is at soccer practice, or other places that the child frequents occasionally, such as friends' houses, etc. Additionally or alternatively, an individual may submit or add to a location digest 302 an ad hoc location report that is entered manually for a person 102 if the person is currently at a location 304 (e.g., a parent may enter “ . . . my child is currently at Evergreen Park . . . ”). These locations and times may be used as a proxy for the actual person's physical location if they do not wear a tracking device. However, claimed subject matter is not limited to any particular scheme for creating, providing, or obtaining a location digest 302.

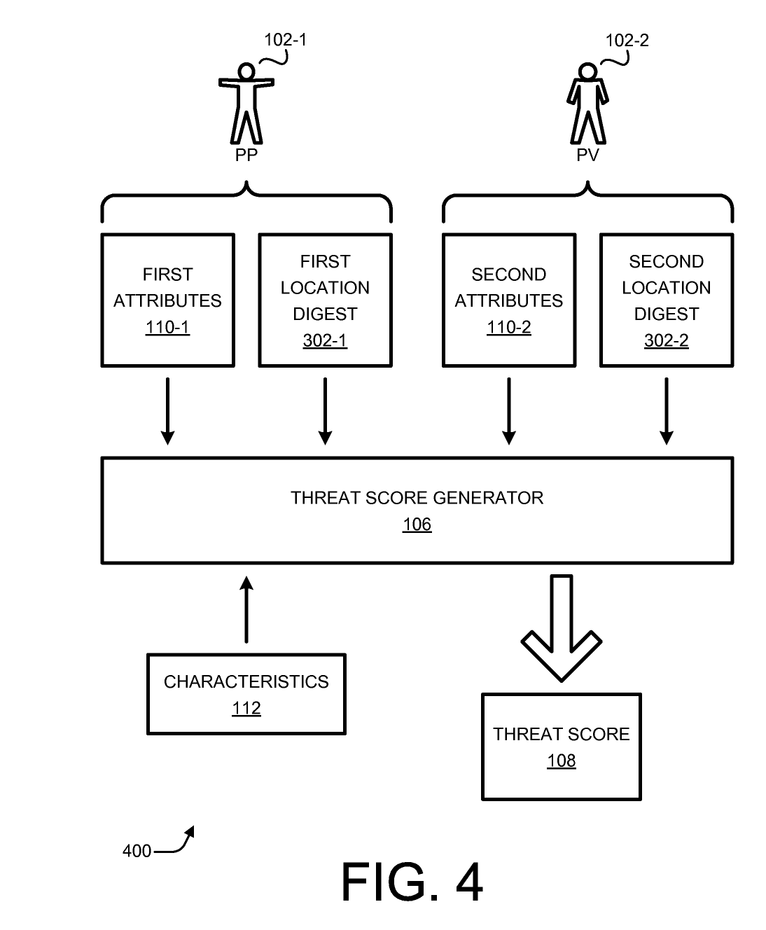

FIG. 4 is a schematic diagram 400 of an example threat score generation mechanism to generate a threat score 108 based, at least in part, on one or more attributes of persons or at least one location digest according to an implementation. As illustrated, schematic diagram 400 may include a potential predator 102-1, a potential victim 102-2, a threat score generator 106, a threat score 108, one or more first attributes 110-1, one or more second attributes 110-2, a first location digest 302-1, a second location digest 302-2, or one or more characteristics 112.

For certain example implementations, first attributes 110-1, first location digest 302-1, second attributes 110-2, or second location digest 302-2 may be transmitted, received, or retrieved from memory, etc. as input signals to a threat score generator 106. Threat score generator 106 may be implemented as hardware, firmware, software, or any combination thereof, etc. Threat score generator 106 may be implemented by a fixed device or a mobile device. For example, a fixed device such as at least one server that is accessible over the Internet may execute code to implement threat score generator 106. As another example, a mobile device such as a mobile phone may execute a downloaded application to implement threat score generator 106. For instance, a user of a mobile device may purchase an app or subscribe to a service to enable them to receive warning alerts that may be responsive to threat scores that are generated locally on the mobile device or generated remotely and delivered to the mobile device.

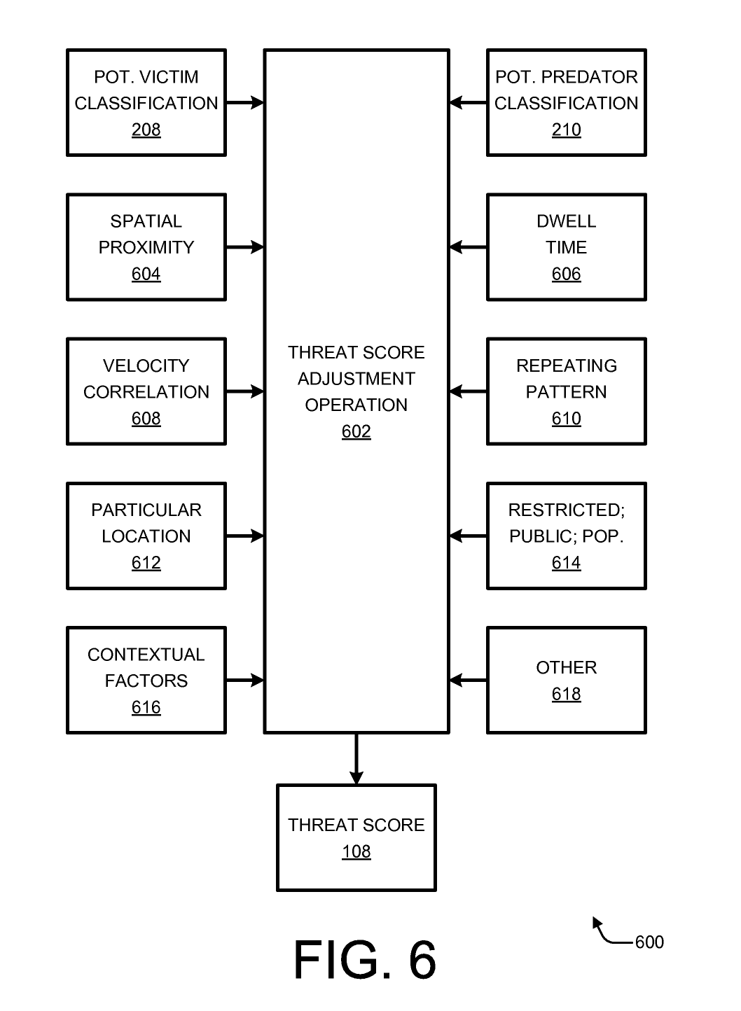

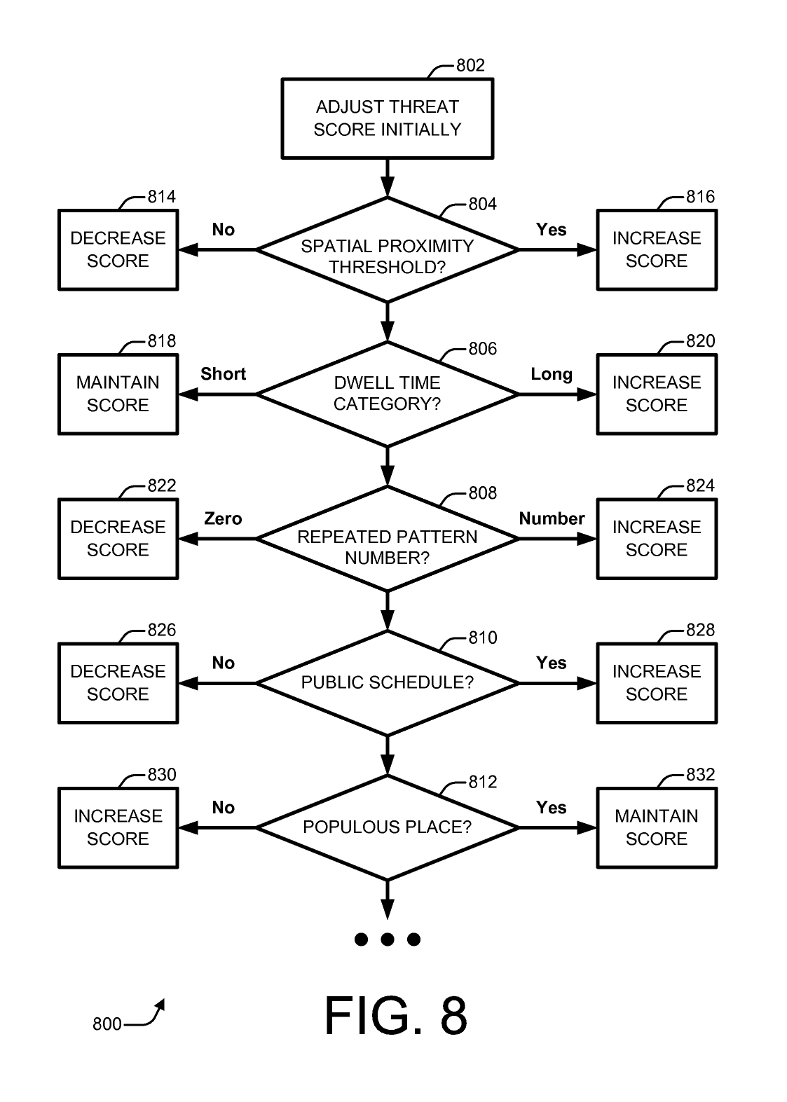

First attributes 110-1 or first location digest 302-1 may be associated with potential predator 102-1. Second attributes 110-2 or second location digest 302-2 may be associated with potential victim 102-2. Based, at least partly, on first attributes 110-1, first location digest 302-1, second attributes 110-2, or second location digest 302-2, threat score generator 106 may generate a threat score 108. In alternative example implementations, threat score generator 106 may further generate threat score 108 based, at least partly, on one or more characteristics 112. Additional examples of characteristics 112 are described herein below with particular reference to FIG. 6 or 8.

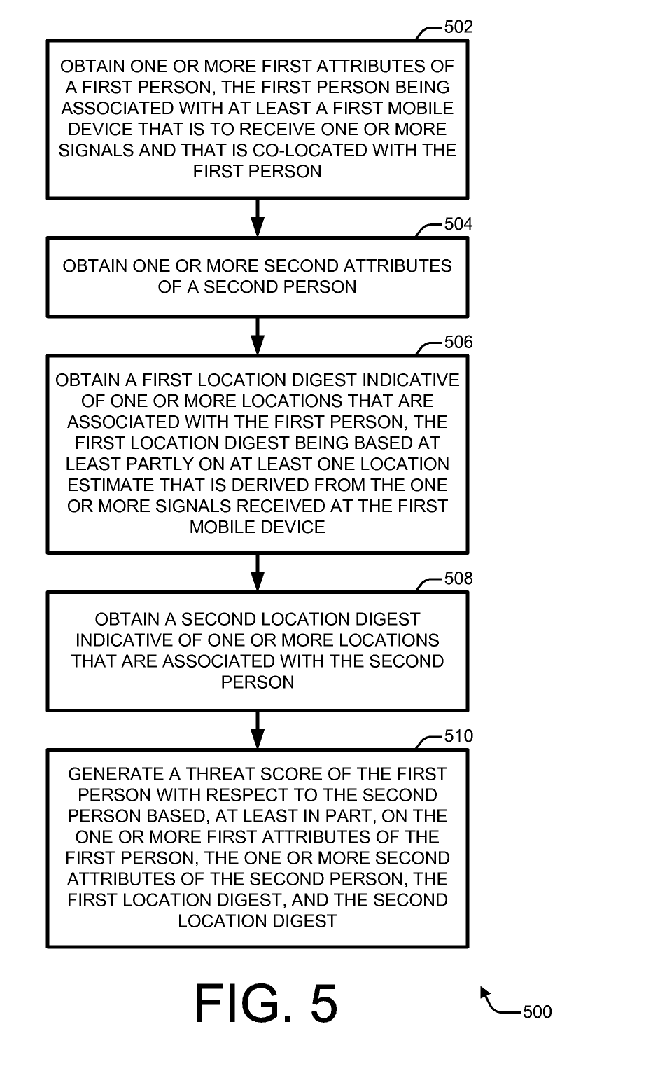

FIG. 5 is a flow diagram 500 illustrating an example method for generating a threat score of a first person with respect to a second person according to an implementation. As illustrated, flow diagram 500 may include any of operations 502-510. Although operations 502-510 are shown and described in a particular order, it should be understood that methods may be performed in alternative manners without departing from claimed subject matter, including but not limited to a different number or order of operations. Also, at least some operations of flow diagram 500 may be performed so as to be fully or partially overlapping with other operation(s). Additionally, although the description below references particular aspects or features illustrated in certain other figures (e.g., FIGS. 1-4), methods may be performed with other aspects or features.

For certain example implementations, one or more of operations 502-510 may be performed at least partially by a fixed device or by a mobile device that is implementing a threat score generator 106. At operation 502, one or more first attributes of a first person may be obtained, with the first person being associated with at least a first mobile device that is to receive one or more signals and that is co-located with the first person. For example, one or more first attributes 110-1 of a first person (e.g., a potential predator 102-1) may be obtained. The first person may be associated with a first mobile device (e.g., a mobile device 308) that is to receive one or more signals and that is co-located with the first person.

At operation 504, one or more second attributes of a second person may be obtained. For example, one or more second attributes 110-2 of a second person (e.g., a potential victim 102-2) may be obtained.

At operation 506, a first location digest indicative of one or more locations that are associated with the first person may be obtained, with the first location digest being based at least partly on at least one location estimate that is derived from the one or more signals received at the first mobile device. For example, a first location digest 302-1 that is associated with the first person (e.g., a potential predator 102-1) may be obtained. At least one location 304 of first location digest 302-1 may be derived at least partly on at least one location estimate that is derived from the one or more signals received at the first mobile device.

At operation 508, a second location digest indicative of one or more locations that are associated with the second person may be obtained. For example, a second location digest 302-2 that is associated with the second person (e.g., a potential victim 102-2) may be obtained. Example implementations relating to obtaining one or more location digests 302 are described herein above with particular reference to at least FIG. 3.

At operation 510, a threat score of the first person with respect to the second person may be generated based, at least in part, on the one or more first attributes of the first person, the one or more second attributes of the second person, the first location digest, and the second location digest. For example, a threat score 108 of the first person (e.g., a potential predator 102-1) with respect to the second person (e.g., a potential victim 102-2) may be generated based, at least in part, on one or more first attributes 110-1 of the first person, one or more second attributes 110-2 of the second person, first location digest 302-1, and second location digest 302-2. Example implementations relating to generating a threat score 108 are described herein with particular reference at least to FIG. 4, 6, or 8.

For certain example implementations, a potential predator classification for at least a first person may be obtained, with the potential predator classification being selected from a first group of multiple potential predator types and with the first person being associated with at least a first mobile device that is to receive one or more signals and that is co-located with the first person. For example, a potential predator classification 210 for at least a first person (e.g., a potential predator 102-1) may be obtained, with potential predator classification 210 being selected from a first group of multiple potential predator types 206. Further, the first person may be associated with at least a first mobile device (e.g., a mobile device 308) that is to receive one or more signals and that is co-located with the first person.

At operation 504, a potential victim classification for at least a second person may be obtained, with the potential victim classification being selected from a second group of multiple potential victim types. For example, a potential victim classification 208 for at least a second person (e.g., a potential victim 102-2) may be obtained, with potential victim classification 208 being selected from a second group of multiple potential victim types 204. Further, the second person may be associated with at least a second mobile device (e.g., a mobile device 308) that is to receive one or more signals and that is co-located with the second person. Example implementations relating to obtaining a potential victim classification 208 or a potential predator classification 210 are described herein above with particular reference to at least FIG. 2.

At operation 506, a first location digest associated with the first person and a second location digest associated with the second person may be obtained, with the first location digest being based at least partly on at least one location estimate that is derived from the one or more signals received at the first mobile device. For example, a first location digest 302-1 associated with a first person (e.g., a potential predator 102-1) and a second location digest 302-2 associated with a second person (e.g., a potential victim 102-2) may be obtained, with first location digest 302-1 being based at least partly on at least one location estimate that is derived from the one or more signals received at the first mobile device that is co-located with the first person. Second location digest 302-2 may further be based at least partly on at least one location estimate that is derived from the one or more signals received at the second mobile device that is co-located with the second person. Example implementations relating to obtaining one or more location digests 302 are described herein above with particular reference to at least FIG. 3.

At operation 508, a threat score of the first person with respect to the second person may be generated based, at least in part, on the potential predator classification, the potential victim classification, the first location digest, and the second location digest. For example, a threat score 108 of a first person (e.g., a potential predator 102-1) with respect to a second person (e.g., a potential victim 102-2) may be generated by a threat score generator 106 based, at least in part, on potential predator classification 210, potential victim classification 208, first location digest 302-1, and second location digest 302-2. Example implementations relating to generating a threat score 108 are described herein with particular reference at least to FIG. 4, 6, or 8.

FIG. 6 is a flow diagram 600 illustrating an example process for generating a threat score 108 according to an implementation. As described above, a threat score generator 106 (e.g., of FIG. 1 or 4) may generate a threat score 108 based at least partly on any of one or more attributes 110 of persons 102 or on any of one or more characteristics 112 (e.g., of FIG. 1 or 4) reflecting an environment in which persons are located, have been located, are likely to be located, or have been barred from being located, etc. Although certain attributes or characteristics are shown in FIG. 6 and described below, more or fewer attributes or characteristics may be considered for a threat score adjustment operation 602 without departing from claimed subject matter.

Threat score 108 may be adjusted via at least one threat score adjustment operation 602 based, at least partly, on attributes or characteristics that may be applied or analyzed in any order, including partially or fully overlapping. A threat score adjustment operation 602 may be performed fully or partially as part of a threat score generation procedure. Additionally or alternatively, a threat score adjustment operation 602 may be performed fully or partially before or after or otherwise during generation of a threat score 108.

For certain example implementations, a threat score 108 may be generated based, at least in part, on multiple variables as described herein. Thus, a threat score may be generated using a multivariate scoring approach that considers a variety of factors, for example. A threat score may also or additionally be generated using a heuristic scoring approach. By way of example but not limitation, a threat score may be based at least partially on evaluation of one or more variables. For instance, multiple variables, such as at least one attribute per person or one or more characteristics, may be monitored over time. Instantaneous locations, changes to location profiles, trends extracted from location profiles, aggregate threat scores, or characteristics, (or any combination thereof), etc. may be heuristically analyzed to determine one or more threat scores. In an example implementation, at least one multivariate heuristic model may be employed to generate a threat score. However, claimed subject matter is not limited to any particular example approach to generating a threat score.

Multiple example attributes or characteristics are shown in flow diagram 600. Attributes or characteristics may be extracted, by way of example but not limitation, from a potential victim classification 208 (e.g., of FIG. 2), a potential predator classification 210, a location digest 302 (e.g., of FIG. 3 or 4), a combination of multiple location digests 302, persons 102 (e.g., of FIG. 1 et seq.), a site 104 (e.g., of FIG. 1), or other aspects of an environment or persons inhabiting or visiting an environment. Example characteristics may include, but are not limited to, spatial proximity 604; dwell time 606; velocity correlation 608; repeating pattern 610; particular location 612; restricted, public, or populous location 614; contextual factors 616, such as a time of day or day of week; other characteristics 618; any combination thereof; etc.

For certain example embodiments, a threat score may be adjusted with a threat score adjustment operation 602 based, at least in part, on a potential victim classification 208 or a potential predator classification 210. For example, a threat score may be initialized or adjusted from a default value based on potential victim classification 208 or potential predator classification 210 or based on a combination of potential victim classification 208 and potential predator classification 210. For instance, a threat score may be increased if a potential victim is classified as a child or if a potential predator is classified as a pedophiliac. If a potential victim is classified as a child and if a potential predator is classified as a pedophiliac, a threat score may be increased more than a sum of separate respective increases because the potential victim is especially likely to be prey of the potential predator.

With a spatial proximity 604 characteristic, a threat score may be adjusted based at least partly on a distance between a potential victim and a potential predator. A threat score may be increased, decreased, or maintained responsive to a comparison between a distance separating a potential victim and a potential predator and at least one threshold distance, which may include a number of threshold distance ranges that may result in a threat score being increased as each successively smaller threshold distance is met. A separation distance between a potential victim and a potential predator may be determined, for example, using location(s) that correspond to an instant of time, that are averaged over a range of times, that are taken at a same time each day, or any combination thereof, etc. Hence, a spatial proximity 604 characteristic may be analyzed in concert with a dwell time 606 characteristic. A dwell time 606 may represent a length of time that elapses as two person have a spatial proximity that meets a given threshold distance. If a dwell time 606 exceeds a time threshold (e.g., while a spatial proximity is being met) for instance, a threat score may be adjusted upward with threat score adjustment operation 602.

A velocity correlation 608 characteristic may be extracted by analyzing location digests 302 associated with a potential victim and a potential predator to detect if any respective velocities have correlated speed or direction. If so, a threat score may be increased. A velocity correlation 608 may be analyzed in concert with spatial proximity or dwell time. For example, if a speed and a direction of a potential predator are detected to match a speed and a direction of a potential victim to a correlation velocity threshold over a given time period threshold, then it may be inferred that the potential predator is following or otherwise stalking the potential victim. Hence, one or more alerts may be issued to either or both persons.

A repeating pattern 610 characteristic may detect whether another characteristic, combination of characteristics, or situation, etc. has repeated one or more times. For example, if an historical movement pattern is determined to repeat, a threat score may be raised with threat score adjustment operation 602. As a more specific example, if a spatial proximity that meets a threshold distance and a dwell time that meets a time threshold have coincided repeatedly (e.g., for three days in a row; for six Saturday afternoons over two months; or at breakfast, lunch, and dinner on a given day; etc.), a threat score may be raised with threat score adjustment operation 602.

A particular location 612 characteristic may relate, for instance, to a specific location that has been designated as being off limits to a potential predator. As a potential predator approaches an off-limits location (e.g., an elementary school), a threat score may be gradually increased accordingly. A restricted, public, or populous location 614 characteristic may relate to locations having a known or expected quality in terms of being forbidden, being private, having a certain population level, or any combination thereof, etc. If a potential predator is detected at a particular location that is restricted for them, then a threat score may be increased. On the other hand, if a potential predator has a known legitimate reason for being at a particular location, then a threat score may be lowered with threat score adjustment operation 602. For example, if a particular location relates to a courthouse where both a potential predator and a potential victim are expected or required to be present at a scheduled time or if a potential predator is located at his or her parent's house, then a threat score may be lowered with threat score adjustment operation 602.

If, for instance, information about a location or a schedule of activities about a location is publicly available via an official news source or via remote observation, a threat score may be increased because a likelihood of a purely coincidental occurrence of spatial proximity may be reduced. If, for instance, a location is known to be densely populated or bustling with activity, a threat score may be reduced, but if a location is known to be sparsely populated or abandoned, a threat score may be raised with threat score adjustment operation 602.

With contextual factor 616 characteristics, factors relating to a context of an environment, such as current conditions thereof, may be applied as part of a threat score adjustment operation 602. For instance, a possible day time encounter may result in a threat score being maintained or lowered, but a possible night time encounter may prompt an increasing of a threat score.

As represented by other characteristics 618, one or more other characteristics, such as those relating to an environment in which two or more persons are located, may also or alternatively be incorporated into a threat score adjustment operation 602 of a threat score generation process. Examples of other characteristics 618 may include, but are not limited to, a relationship between two people, or scores of people who are proximate, etc. For instance, it is more likely that someone is stalking another person if they are divorced spouses or if there was a previous incidence of one person harassing or harming the other, versus if two people are just random strangers. Also, in a group setting, threat scores with respect to other people may be used to adjust a particular threat score with respect to a particular individual. For instance, if child ‘A’ is at school and there is a certain probability that a given person is stalking them based on location digests, but it is known that there is a child ‘B’ at the same school that has an extremely high probability of being stalked by that same given person, then it is more likely that the child ‘A’ is not truly being stalked. Instead, it is likely a coincidence that the child ‘A’ is often in the same place as the child ‘B’ that is actually being stalked.

Examples of other characteristics 618 may further include, but are not limited to, a relationship between threat scores and a particular location or a particular time, or a threat score history, etc. For instance, threat scores may be associated with sites or time periods. Threat scores of a potential predator may be generated that match a certain threat category with respect to multiple potential victims, but interactions between the potential predator and the potential victims are centered around a particular location (or a set of particular locations) or around certain times. Generating threat scores around a particular location or particular time window may indicate that an assault is likely to happen at that particular location or that particular time window (e.g., where or when children are released from a school).

Additionally or alternatively, a history of threat scores may be maintained over time. Maintained threat scores may be processed, such as by combining threat scores, by decaying certain threat scores, some combination thereof, etc. For example, older threat scores may be weighted less heavily as compared to newer or latest threat scores. Threat score trend information extracted from a history of threat scores may be used to generate a composite threat score that is informed by a historical trend. For example, if a composite threat score for a particular time of day is increasing over time, it may indicate an increasing likelihood that a “bad event” is about to happen, even more so than if a latest threat score were considered independently. Conversely, a falling composite threat score may indicate the opposite—that a “bad event” is decreasingly less likely to happen. Thus, an imminent threat versus a non-imminent threat may be discernable based at least partly on a history of threat scores.

A stream of threat scores may be analyzed to form short-term threat scores or long-term threat scores. For example, a trend of threat scores may be determined by analyzing a stream of instantaneous or snapshot threat scores. A short-term threat score may indicate how likely an encounter or an incident of harm is to occur right now. Even if a short-term threat score is not sufficiently high so as to generate an alert, a long-term threat score may indicate that some level of concern is warranted. If an historical trend of threat scores generates a long-term threat score that is of concern, then a more in-depth analysis of personal attributes, location digests, etc. may be undertaken. A long-term threat score may be more likely to reflect long-term patterns, such as movement mirroring, repeated near-encounters, etc.

Further examples of other characteristics 618 may include, but are not limited to, generating aggregate threat scores across multiple individuals. A threat score may be generated with respect to an individual. Alternatively, an aggregate threat score may be generated with respect to multiple individuals. For example, no individual threat score for individuals forming a group of potential victims may be sufficiently high so as to trigger an alert. An aggregate threat score, on the other hand, may indicate that a potential predator is stalking at least one of the individuals in the group of potential victims. If there is a disparity among individual threat scores and an aggregate threat score, further analysis, investigation, or monitoring may be performed to attempt to determine a likely potential victim from the group of potential victims. Accordingly, claimed subject matter is not limited to those characteristics, or example applications thereof, that are explicitly described with reference to FIG. 6.

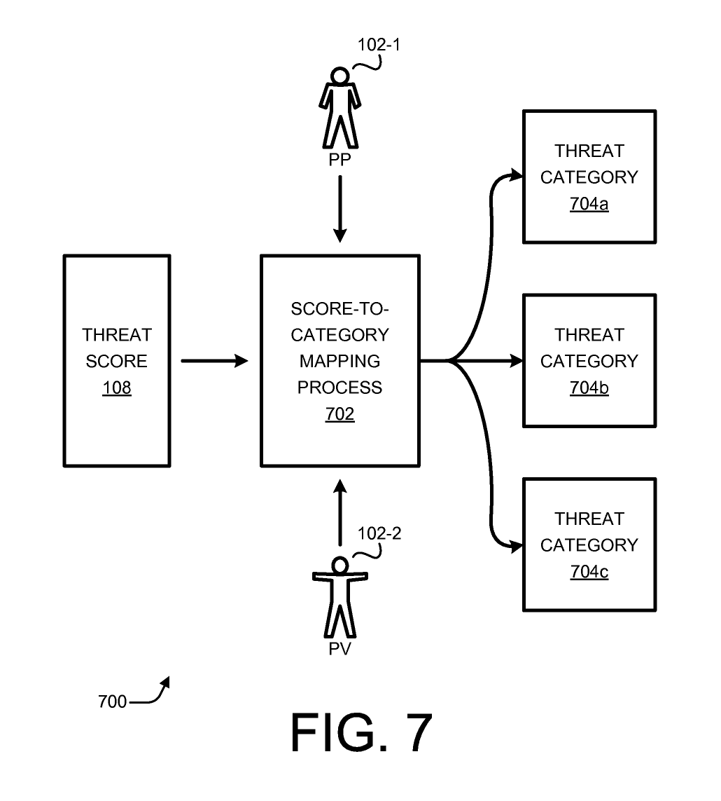

FIG. 7 is a schematic diagram 700 illustrating an example mechanism for converting a threat score 108 to a threat category 704 according to an implementation. For certain example implementations, a threat score 108 may be mapped to one or more threat categories 704a, 704b, or 704c via a score-to-category mapping process 702. A threat score 108, which may be a numerical score, may be mapped to at least one threat category 704 of multiple threat categories 704a, 704b, or 704c. Categories may correspond, for example, to overlapping threat levels or mutually-exclusive threat levels, but claimed subject matter is not limited to any particular kind of categories.

A mapping may be consistent across a number of potential victims 102-2 or potential predators 102-1. Alternatively, an individual identity of a potential victim 102-2 or a potential predator 102-1 may affect a mapping from threat score to threat category. For example, a non-violent or one-time predator, who is considered a potential predator 102-1, with a given threat score may receive a reminder alert if they are approaching a restricted area or person while a violent or repeat predator with the same given threat score may have a notification alert issued about them to a police department. As another example, different potential victims 102-2 may have different tolerance levels for receiving alerts or possible false positives. Hence, one potential victim may request that a given threat score 108 map to a threat category 704 that initiates or triggers an alert to be issued to them, but another potential victim may request that the same given threat score 108 not map to a threat category 704 that initiates or triggers an alert to be issued.

Threat categories 704a, 704b, or 704c may correspond to different concepts or actions. For example, threat categories 704a, 704b, or 704c may correspond to labels, such as high, medium, or low threat categories. Alternatively, threat categories 704a, 704b, or 704c may correspond to monitoring categories, such as continuous location monitoring (e.g., as continuous as practical—such as every second, every few seconds, or every few minutes), hourly location monitoring, or daily location monitoring. As another alternative, threat categories 704a, 704b, or 704c may correspond to alert categories. Alert categories may comprise, by way of example but not limitation, issuing a warning alert to a potential victim 102-2, issuing a notification alert to at least one protective authority member or other member of a protector classification (e.g., a police officer, a parole officer, or a parent, etc.), issuing a reminder alert to a potential predator 102-1, or some combination thereof, etc. Although three threat categories 704a, 704b, or 704c are explicitly shown in FIG. 7 and described herein, a threat score 108 may alternatively be mapped to a different number of threat categories without departing from claimed subject matter.

FIG. 8 is a flow diagram 800 illustrating an example specific process for generating a threat score according to an implementation. As illustrated, flow diagram 800 may include any of operations 802-832. Although operations 802-832 are shown and described in a particular order, it should be understood that processes may be performed in alternative manners without departing from claimed subject matter, including but not limited to a different number or order of operations. Also, at least some operations of flow diagram 800 may be performed so as to be fully or partially overlapping with other operation(s).

For certain example implementations, at operation 802, a threat score may be adjusted initially. For example, a threat score may be established or modified based at least partly on a potential victim classification or a potential predator classification. At operation 804, it may be determined if a spatial proximity between a potential victim and a potential predator meets a distance threshold. If so, then a threat score may be increased at operation 816. If not, then a threat score may be decreased at operation 814.

At operation 806, a dwell time during which a spatial proximity meets a distance threshold may be categorized. If a dwell time corresponds to a long dwell time category, then a threat score may be increased at operation 820. On the other hand, if a dwell time corresponds to a short dwell time category, then a threat score may be maintained with no change at operation 818.

At operation 808, a number of times at which a pattern has been repeated may be determined. If a pattern has not been repeated or there is no pattern detected, a threat score may be decreased at operation 822. This may reduce a likelihood that a false positive is reported. If, on the other hand, a number of times at which a pattern has been repeated is determined, then a threat score may be increased at operation 824 in accordance with the determined number of pattern repetitions. For example, a threat score may be increased according to (e.g., proportional to) a size of the determined number of pattern repetitions.

At operation 810, it may be determined if a potential victim's presence at a given location may be ascertained from publicly-available information (e.g., in accordance with a schedule). If so, then at operation 828 a threat score may be increased. If not, then a threat score may be decreased at operation 826.

At operation 812, it may be determined if a location or area at which a potential victim and a potential predator meet a distance threshold comprises a populous place. If yes the area is densely populated, then a threat score may be maintained at operation 832 without increase or decrease. If the area is a sparsely-populated place on the other hand, then a threat score may be increased at operation 830. It should be understood that the above-described characteristics or parameters are provided by way of example only and that claimed subject matter is not limited to any particular characteristics, parameters, score adjustment paradigms, or analysis order, etc.

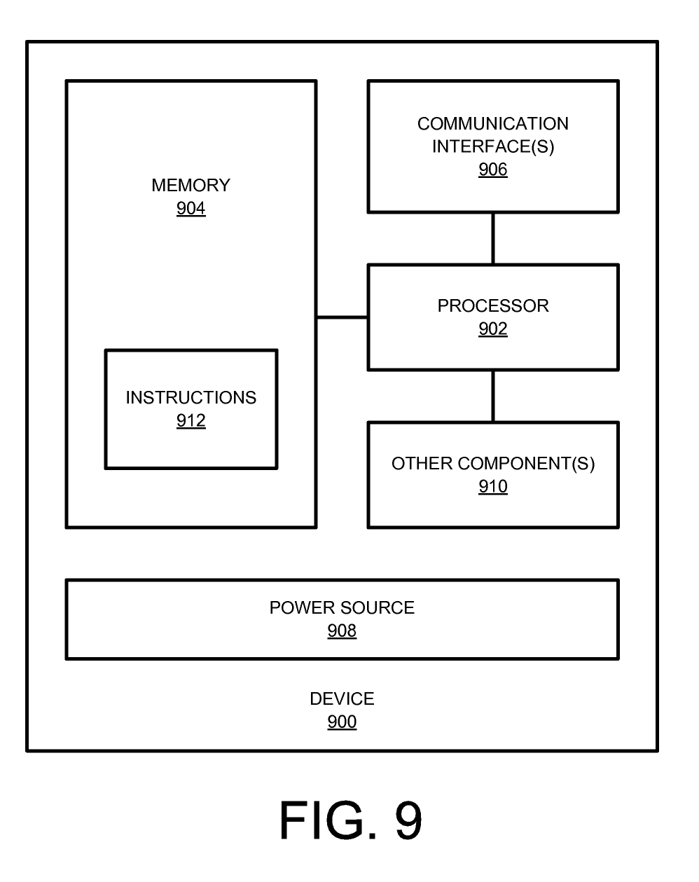

FIG. 9 is a schematic diagram illustrating an example device 900, according to an implementation, that may implement one or more aspects of generating a threat score of a first person, such as a potential predator, with respect to a second person, such as a potential victim. As illustrated, device 900 may include at least one processor 902, one or more memories 904, at least one communication interface 906, at least one power source 908, or other component(s) 910, etc. Memory 904 may store instructions 912. However, a device 900 may alternatively include more, fewer, or different components from those that are illustrated without deviating from claimed subject matter.

For certain example implementations, device 900 may include or comprise at least one electronic device. Device 900 may comprise, for example, a computing platform or any electronic device having at least one processor or memory. Examples for device 900 include, but are not limited to, fixed processing devices, mobile processing devices, or electronic devices generally, etc. Fixed processing devices may include, but are not limited to, a desktop computer, one or more server machines, at least one telecommunications node, an intelligent router/switch, an access point, a distributed computing network, or any combination thereof, etc. Mobile processing devices may include, but are not limited to, a notebook computer, a personal digital assistant (PDA), a netbook, a slate or tablet computer, a portable entertainment device, a mobile phone, a smart phone, a mobile station, user equipment, a personal navigational device (PND), a monitoring bracelet or similar, or any combination thereof, etc. For a mobile device implementation of device 900, other components 910 may include, for example, an SPS unit (SPSU) or other sensor(s), e.g. to obtain positioning data.

Power source 908 may provide power to components or circuitry of device 900. Power source 908 may be a portable power source, such as a battery, or a fixed power source, such as an outlet or other conduit in a car, house, or other building to a utility power source. Power source 908 may also be a transportable power source, such as a solar or carbon-fuel-based generator. Power source 908 may be integrated with or separate from device 900.

Processor 902 may comprise any one or more processing units. Memory 904 may store, contain, or otherwise provide access to instructions 912 (e.g., a program, an application, etc. or portion thereof; operational data structures; processor-executable instructions; code; or any combination thereof; etc.) that may be executable by processor 902. Execution of such instructions 912 by one or more processors 902 may transform device 900 into a special-purpose computing device, apparatus, platform, or any combination thereof, etc. Instructions 912 may correspond to, for example, instructions that are capable of realizing at least a portion of one or more flow diagrams methods, processes, operations, or mechanisms, etc. that are described herein or illustrated in the accompanying drawings. Instructions 912 may further include, by way of example but not limitation, information (e.g., potential predator types, potential victim types, classifications, or locations digests, etc.) that may be used to realize flow diagrams methods, processes, operations, or mechanisms, etc. that are described herein or illustrated in the accompanying drawings.

Communication interface(s) 906 may provide one or more interfaces between device 900 and another device or a human operator. Communication interface 906 may include a screen, a speaker, a keyboard or keys, or other human-device input/output features. Communication interface 906 may also or alternatively include a transceiver (e.g., transmitter or receiver), a radio, an antenna, a wired interface connector or other similar apparatus, a physical or logical network adapter or port, or any combination thereof, etc. to communicate wireless and/or wired signals via one or more wireless or wired communication links, respectively. Such communications with at least one communication interface 906 may enable transmitting, receiving, or initiating of transmissions, just to name a few examples. Communication interface 906 may also serve as a bus or other interconnect between or among other components of device 900. Other component(s) 910 may comprise one or more other miscellaneous sensors, or features, etc.

Methodologies described herein may be implemented by various means depending upon applications according to particular features or examples. For example, such methodologies may be implemented in hardware, firmware, software, discrete or fixed logic circuitry, or any combination thereof, etc. In a hardware or logic circuitry implementation, for example, a processor or processing unit may be implemented within one or more application specific integrated circuits (ASICs), digital signal processors (DSPs), digital signal processing devices (DSPDs), programmable logic devices (PLDs), field programmable gate arrays (FPGAs), processors generally, controllers, micro-controllers, microprocessors, electronic devices, other devices or units programmed to execute instructions or designed to perform functions described herein, or any combinations thereof, just to name a few examples. As used herein, the term “control logic” may encompass logic implemented by software, hardware, firmware, discrete or fixed logic circuitry, or any combination thereof, etc.

For at least firmware and/or software implementations, methodologies may be implemented with modules (e.g., procedures, functions, etc.) having instructions that perform functions described herein. Any machine readable medium tangibly embodying instructions may be used in implementing methodologies described herein. For example, software coding may be stored in a memory and executed by a processor. Memory may be implemented within a processor or external to a processor. As used herein, the term “memory” may refer to any type of long term, short term, volatile, nonvolatile, or other storage or non-transitory memory or medium, and it is not to be limited to any particular type of memory or number of memories, or type of media upon which memory is stored.

In one or more example implementations, functions described herein may be implemented in hardware, software, firmware, discrete or fixed logic circuitry, or any combination thereof, etc. If implemented in firmware or software, functions may be stored on a physical computer-readable medium (e.g., via electrical digital signals) as one or more instructions or code. Computer-readable media may include physical computer storage media that may be encoded with a data structure, computer program, or any combination thereof, etc. A storage medium may be any available physical non-transitory medium that may be accessed by a computer. By way of example but not limitation, such computer-readable media may comprise RAM, ROM, or EEPROM; CD-ROM or other optical disc storage; magnetic disk storage or other magnetic storage devices; or any other medium that may be used to store program code in a form of instructions or data structures or that may be accessed by a computer or processor thereof. Disk and disc, as used herein, may include compact disc (CD), laser disc, optical disc, digital versatile disc (DVD), floppy disk, or blu-ray disc, where disks may reproduce data magnetically, while discs may reproduce data optically with lasers.

Also, computer instructions, code, or data, etc. may be transmitted via signals over physical transmission media from a transmitter to a receiver (e.g., via electrical binary digital signals). For example, software may be transmitted to or from a website, server, or other remote source using a coaxial cable; a fiber optic cable; a twisted pair; a digital subscriber line (DSL); or physical components of wireless technologies such as infrared, radio, or microwave, etc. Combinations of the above may also be included within the scope of physical transmission media. Computer instructions or data may be transmitted in portions (e.g., first and second portions) or at different times (e.g., at first and second times).

Electronic devices may also operate in conjunction with Wi-Fi, WiMAX, WLAN, or other wireless networks. For example, signals that may be used as positioning data may be acquired via a Wi-Fi, WLAN, or other wireless network. In an example implementation, a wireless receiver (e.g., of a mobile device) may be capable of receiving signals or determining a location of a device using a Wi-Fi, WiMAX, WLAN, etc. system or systems. For instance, a mobile device may receive signals that are related to received signal strength indicator (RSSI) transmissions, or round trip time (RTT), transmission, etc. to facilitate determining a location. Certain implementations may also be applied to femtocells or a combination of systems that includes femtocells. For example, femtocells may provide data and/or voice communication. Moreover, femtocells may transmit signals that may be used as positioning data.

In addition to Wi-Fi/WLAN signals, a wireless or mobile device may also receive signals from satellites, which may be from a Global Positioning System (GPS), Galileo, GLONASS, NAVSTAR, QZSS, a system that uses satellites from a combination of these systems, or any SPS developed in the future, each referred to generally herein as a Satellite Positioning System (SPS) or GNSS (Global Navigation Satellite System). Furthermore, implementations described herein may be used with positioning determination systems that utilize pseudolites or a combination of satellites and pseudolites. Pseudolites are usually ground-based transmitters that broadcast a Pseudo-Random Noise (PRN) code or other ranging code (e.g., similar to a GPS or CDMA cellular signal) that is modulated on an L-band (or other frequency) carrier signal, which may be synchronized with GPS time. Each such transmitter may be assigned a unique PN code so as to permit identification by a remote receiver. Pseudolites may be particularly useful in situations where SPS signals from an orbiting satellite might be unavailable, such as in tunnels, mines, buildings, urban canyons, or other enclosed areas. Another implementation of pseudolites is known as radio-beacons. Thus, the term “satellite”, as used herein, may also include pseudolites, equivalents of pseudolites, and similar and/or analogous technologies. The term “SPS signals”, as used herein, may also include SPS-like signals from pseudolites or equivalents of pseudolites. In an example implementation, an SPS unit (e.g., of a mobile device) may be capable of receiving signals or determining a location of a device using an SPS system or systems. Hence, example implementations that are described herein may be used with various SPSs. An SPS typically includes a system of transmitters positioned to enable entities to determine their location on or above the Earth based, at least in part, on signals received from the transmitters. A transmitter typically, but not necessarily, transmits a signal marked with a repeating pseudo-random noise (PN) code of a set number of chips and may be located on ground based control stations, user equipment, and/or space vehicles. As used herein, an SPS may include any combination of one or more global or regional navigation satellite systems or augmentation systems, and SPS signals may include SPS, SPS-like, or other signals associated with such one or more SPSes.

Some portions of this Detailed Description are presented in terms of algorithms or symbolic representations of operations on binary digital signals that may be stored within a memory of a specific apparatus or special purpose computing device or platform. In the context of this particular Specification, the term specific apparatus or the like includes a general purpose computer once it is programmed to perform particular functions pursuant to instructions from program software/instructions. Algorithmic descriptions or symbolic representations are examples of techniques used by those of ordinary skill in the signal processing or related arts to convey the substance of their work to others skilled in the art. An algorithm here, and generally, may be considered to be a self-consistent sequence of operations or similar signal processing leading to a desired result. In this context, operations or processing involve physical manipulation of physical quantities. Typically, although not necessarily, such quantities may take the form of electrical and/or magnetic signals capable of being stored, transferred, combined, compared, transmitted, received, or otherwise manipulated.

It has proven convenient at times, principally for reasons of common usage, to refer to such signals as bits, data, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “obtaining,” “transmitting,” “receiving,” “identifying,” “utilizing,” “performing,” “applying,” “positioning/locating,” “analyzing,” “storing,” “generating,” “estimating,” “adjusting,” “increasing,” “decreasing,” “maintaining,” “initiating (e.g., transmission),” or the like refer to actions or processes of a specific apparatus, such as a special purpose computer or a similar special purpose electronic computing device or platform. In the context of this Specification, therefore, a special purpose computer or a similar special purpose electronic computing device or platform may be capable of manipulating, storing in memory, or transforming signals, typically represented as physical electronic, electrical, and/or magnetic quantities within memories, registers, or other information storage devices, transmission devices, or display devices of a special purpose computer or similar special purpose electronic computing device or platform.

Likewise, the terms, “and” and “or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic, etc. in the singular or may be used to describe some combination of features, structures, or characteristics, etc. However, it should be noted that this is merely an illustrative example and claimed subject matter is not limited to this example.

Although there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from central concepts described herein. Therefore, it is intended that claimed subject matter not be limited to particular examples disclosed, but that such claimed subject matter may also include all aspects falling within the scope of appended claims, and equivalents thereof.

What is claimed is:

1. A method comprising:
obtaining one or more first attributes of a first person, the first person being associated with at least a first mobile device that is to receive one or more signals and that is co-located with the first person;
obtaining one or more second attributes of a second person;
obtaining a first location digest indicative of one or more locations that are associated with the first person, the first location digest being based at least partly on at least one location estimate that is derived from the one or more signals received at the first mobile device;
obtaining a second location digest indicative of one or more locations that are associated with the second person; and
generating a threat score of the first person with respect to the second person based, at least in part, on the one or more first attributes of the first person, the one or more second attributes of the second person, the first location digest, and the second location digest.

2. The method of claim 1, wherein said generating further comprises:
applying a multivariate heuristic model at least to the one or more first attributes of the first person, the one or more second attributes of the second person, the first location digest, and the second location digest to generate the threat score.

3. The method of claim 1, wherein the one or more first attributes of the first person comprise a potential predator classification and the one or more second attributes of the second person comprise a potential victim classification.

4. The method of claim 3, further comprising:
obtaining the potential predator classification for the first person, the potential predator classification being selected from a first group of multiple potential predator types; and
obtaining the potential victim classification for the second person, the potential victim classification being selected from a second group of multiple potential victim types.

5. The method of claim 4, wherein a potential predator type of the first group of multiple potential predator types is selected from a group comprising: a previous predator, a previous offender, a recidivist of a particular criminal action or category, an individual that has exhibited suspicious behavior, an individual that is a subject of a restraining order, an individual that has been accused of a crime, or an individual that has been charged with a crime.

6. The method of claim 4, wherein a potential victim type of the second group of multiple potential victim types is selected from a group comprising a minor, a child in a particular age range, a woman, a woman in a given age range, an individual living near a known prior predator, an individual who drives a particular car or a car having a particular value range, an individual traveling alone, or a person that lives in a particular neighborhood.

7. The method of claim 1, wherein the one or more first attributes of the first person and the one or more second attributes of the second person comprise one or more attributes that are selected from a group comprising: age, gender, recidivism, victimhood, habits, marital status, psychological profile indications, employment, education, physical size, appearance, group affiliations, location history, residence, wealth, profession, income, or avocations.

8. The method of claim 1, wherein the second location digest relates the one or more locations that are associated with the second person to a presence of the second person; and wherein the presence of the second person is indicative of one or more statuses that are selected from a group comprising: an intent to visit the one or more locations that are associated with the second person, a current visit to the one or more locations that are associated with the second person, a previous visit to the one or more locations that are associated with the second person, a scheduled visit to the one or more locations that are associated with the second person, or a recurring visitation to the one or more locations that are associated with the second person.

9. The method of claim 1, wherein said generating further comprises:
generating a composite threat score that is indicative of a trend of multiple threat scores.

10. The method of claim 1, wherein said generating further comprises:
generating an aggregate threat score that is indicative of at least one threat level for a group of multiple potential victims.

11. The method of claim 1, wherein said generating further comprises:
generating the threat score to reflect a history of locations indicated in at least one of the first location digest or the second location digest.

12. The method of claim 1, further comprising:
converting the threat score to a threat category; and
determining whether to issue an alert based at least partly on the threat category.

13. The method of claim 12, further comprising:
initiating transmission of a warning alert to the second person based at least partly on said determining.

14. The method of claim 12, further comprising:
initiating transmission of a notification alert to at least one person who is a member of a protector classification based at least partly on said determining.

15. The method of claim 12, further comprising:
initiating transmission of a reminder alert to the first person via the first mobile device based at least partly on said determining.

16. The method of claim 1, wherein at least the first location digest indicates a historical movement pattern by including multiple location estimates, which are derived from the one or more signals received at the first mobile device, of the first person at multiple instances; and wherein said generating further comprises:
generating the threat score of the first person with respect to the second person based, at least in part, on the historical movement pattern indicated by the first location digest.

17. A device comprising:
at least one memory to store instructions; and
one or more processors to execute said instructions to:
obtain one or more first attributes of a first person, the first person being associated with at least a first mobile device that is to receive one or more signals and that is co-located with the first person;
obtain one or more second attributes of a second person;
obtain a first location digest indicative of one or more locations that are associated with the first person, the first location digest being based at least partly on at least one location estimate that is derived from the one or more signals received at the first mobile device;
obtain a second location digest indicative of one or more locations that are associated with the second person; and
generate a threat score of the first person with respect to the second person based, at least in part, on the one or more first attributes of the first person, the one or more second attributes of the second person, the first location digest, and the second location digest.

18. The device of claim 17, wherein to generate the threat score said one or more processors are further to execute said instructions to:
generate the threat score of the first person with respect to the second person based, at least in part, on one or more characteristics.

19. The device of claim 18, wherein the one or more characteristics comprise at least one distance separating the first person and the second person and a threshold distance, with the at least one distance separating the first person and the second person being determinable from the first location digest and the second location digest.

20. The device of claim 19, wherein the one or more characteristics comprise a number of repetitions at which the at least one distance separating the first person and the second person meets the threshold distance.

21. The device of claim 19, wherein the one or more characteristics comprise at least one dwell time that elapses if the at least one distance separating the first person and the second person meets the threshold distance.

22. The device of claim 18, wherein the one or more characteristics comprise a time of day or a population level of a given location.

23. The device of claim 18, wherein the second person is associated with at least a second mobile device that is to receive one or more signals and is co-located with the second person, and wherein the second location digest is based at least partly on at least one location estimate that is derived from the one or more signals received at the second mobile device.

24. The device of claim 18, wherein the second location digest is based at least partly on at least one location that is provided manually by the second person.

25. An apparatus comprising:
means for obtaining one or more first attributes of a first person, the first person being associated with at least a first mobile device that is to receive one or more signals and that is co-located with the first person;
means for obtaining one or more second attributes of a second person;
means for obtaining a first location digest indicative of one or more locations that are associated with the first person, the first location digest being based at least partly on at least one location estimate that is derived from the one or more signals received at the first mobile device;
means for obtaining a second location digest indicative of one or more locations that are associated with the second person; and
means for generating a threat score of the first person with respect to the second person based, at least in part, on the one or more first attributes of the first person, the one or more second attributes of the second person, the first location digest, and the second location digest.

26. The apparatus of claim 25, wherein the first location digest is based at least partly on at least one location estimate that is derived from one or more signals received at a first mobile device that is co-located with the first person, and the second location digest is based at least partly on at least one location estimate that is derived from one or more signals received at a second mobile device that is co-located with the second person.

27. The apparatus of claim 25, wherein said means for generating comprises:
means for adjusting the threat score based at least partly on one or more characteristics.

28. The apparatus of claim 25, further comprising:
means for mapping the threat score to at least one threat category of multiple threat categories.

29. An article comprising: at least one storage medium having stored thereon instructions executable by one or more processors to:
obtain one or more first attributes of a first person, the first person being associated with at least a first mobile device that is to receive one or more signals and that is co-located with the first person;
obtain one or more second attributes of a second person;
obtain a first location digest indicative of one or more locations that are associated with the first person, the first location digest being based at least partly on at least one location estimate that is derived from the one or more signals received at the first mobile device;
obtain a second location digest indicative of one or more locations that are associated with the second person; and
generate a threat score of the first person with respect to the second person based, at least in part, on the one or more first attributes of the first person, the one or more second attributes of the second person, the first location digest, and the second location digest.
